(19) United States
(12) Patent Application Publication
(10) Pub. No.: US 2007/0225047 A1
(43) Pub. Date: Sep. 27, 2007

(54) Automatic discovery and deployment of feed links to mobile terminals

(75) Inventor: Balazs Bakos, Budapest (HU)

Correspondence Address: BANNER & WITCOFF, LTD., 1100 13th STREET, N.W., SUITE 1200, WASHINGTON, DC, 20005-4051, US

(73) Assignee: Nokia Corporation

(21) Appl. No.: 11/384,509

(22) Filed: Mar. 21, 2006

(51) Int. Cl. H04M 1/00; H04B 1/38

(52) U.S. Cl. 455/566

(57) ABSTRACT

Systems and methods are provided for discovering and deploying web feed links to mobile terminals. A personal computer in communication with the mobile terminal, for example, via a Bluetooth connection, may monitor the web browsing activities of the user on the computer and create a report based on this information. Such a report may contain data regarding the web sites visited by the user, and feed links available for those sites. The report may be transmitted to the user's mobile terminal, allowing the mobile terminal to automatically subscribe to and unsubscribe from web feeds, such as, for example, RSS feeds.

### BACKGROUND

The development of web feed ‘publish and subscribe’ applications has greatly enhanced the media consumption experience for mobile terminal users. Web feed technologies allow users to subscribe to a content delivery service provided by certain web servers. Thus, rather than needing to frequently search for relevant news or newly posted content on a web site, the content can be sent directly to web feed subscribers. After a mobile terminal has subscribed to a particular web feed, content from the feed may be automatically downloaded as a background process on the mobile terminal, without requiring any specific user action to retrieve the updated content. Since web browsing is often more difficult on mobile terminals, new subscribe and publish applications such as newsreader or podcasting applications, built on technologies such as Really Simple Syndication (RSS) feeds and Atom feeds, provide a solution to reduce circuitous and repetitive web browsing on mobile terminals.

However, before a mobile terminal user may enjoy the advantages of web feed application, a subscription must first be created on the mobile terminal. This can be a complicated multi-step process. In many cases, a personal computer may be connected to the mobile terminal with a proximity link such as a Bluetooth connection. Bluetooth technology is a low-power, short-range wireless technology commonly used to provide a replacement for the serial cable.

Referring to FIG. 1, a diagram is shown illustrating a conventional method of discovering and subscribing to a web feed on a mobile terminal 20 attached to a personal computer 10 via a short-range link such as a Bluetooth connection. A user browsing the internet on a personal computer 10 visits a web site hosted by a remote server 30 that contains content relevant to the user's interests. In this example, the user has browsed to a web site hosted by the Financial Times®, located at the web address http://news.ft.com/home/us. The user may decide to subscribe to a web feed associated with this site, in order to automatically receive content updates, such as Financial Times® news headlines, on the user's mobile terminal 20. The user begins by manually searching the different web pages of the site on the remote server 30, looking for information relating to any supported web feeds. Many web sites/web servers do not provide web feed applications, and many others that do may display the needed information in obscure locations on the web page or on another web page in the site. Thus, the user's search may take a considerable amount of time, and may ultimately be unsuccessful.

In this example, the user has discovered that the remote server 30 supports an RSS web feed for this site. The user must then discover the uniform resource locator (URL) of the RSS feed link, for example, by clicking on the RSS icon and observing the web address displayed in the address tool bar of the browser window. The user may then need to remember or write down the RSS feed link address. This URL, like typical web site addresses, may be long and difficult to remember or even write down correctly, making the process even more difficult.

Then the user inputs the RSS feed link URL into the mobile terminal 20. Before inputting the URL directly, the user must find the “Enter the Feed's URL” dialog, or comparable screen within the task hierarchy of the mobile terminal 20. Inputting the RSS feed link URL may itself be an inconvenient task, requiring the user to exactly input the long URL string with the limited keyboard or other input mechanisms provided on the mobile terminal 20. Only after the completion of the above steps will the user's mobile terminal 20 be set up to receive the RSS feed data from the remote server 30.

The illustrative steps described above for creating a web feed subscription are often difficult and subject to user errors. Accordingly, there remains a need for methods and systems of feed link discovery and deployment on mobile terminals.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a user may access resources over a network, for example, by visiting internet web sites from a personal computer. The web browsing activities of the user may be logged and transmitted to the user's mobile terminal. Subscriptions to various web feeds, for example, RSS feeds, may be automatically created at the mobile terminal based on the web browsing data recorded at the personal computer.

According to another aspect of the present disclosure, a software component at a personal computer, for example, a browser plug-in, may create a log of the web sites visited by the user on the computer, the frequency of visits to the user's favorite web sites, and other network locations that may be relevant to the user. The browser plug-in may also search these web sites and related sites to discover feed links, for example, RSS feed links, to which the user may want to subscribe. A sorted report including these feed links may be generated and transmitted to the user's mobile terminal, for example, via a Bluetooth connection.

According to yet another aspect of the present disclosure, a second software component at the user's mobile terminal may process the web browsing data and feed links received from the computer. The mobile terminal may select the most relevant feed links from the report and may automatically subscribe to these web feeds. Similarly, the mobile terminal may unsubscribe to certain other web feeds that are determined as less relevant to the user. The subscription determinations may be made based on the report received from the connected personal computer, the current set of feed subscriptions on the mobile terminal, user preferences, and/or confirmation received from the user in response to a suggested feed subscription action.

Thus, according to some aspects of the present disclosure, feed link subscription behavior on mobile terminals may be improved by providing for automatic discovery of feed links from frequently visited web sites and direct deployment actions taken by the computer and mobile terminal, without requiring a difficult multi-step user task to establish and maintain feed link subscriptions

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a conventional method of interaction between a computer, remote server, mobile terminal, and a user, relating to discovery and deployment of web feed links;

FIG. 2 is a block diagram illustrating a mobile terminal, in accordance with one or more aspects of the present disclosure;

FIG. 3 is a block diagram showing illustrative steps for discovering and deploying a web feed link by a mobile terminal to a remote server, in accordance with one or more illustrative aspects of the present disclosure;

FIG. 4 is a block diagram illustrating the discovering and deployment of a web feed link on a mobile terminal, in accordance with one or more illustrative aspects of the present disclosure;

FIG. 5 is a flowchart showing illustrative steps for providing web feed link information to a mobile terminal, in accordance with one or more illustrative aspects of the present disclosure; and

FIG. 6 is a flowchart showing illustrative steps for establishing and maintaining web feed subscriptions at a mobile terminal, in accordance with one or more illustrative aspects of the present disclosure.

### DETAILED DESCRIPTION OF ILLUSTRATIVE EMBODIMENTS

Illustrative embodiments will now be described more fully with reference to the accompanying drawings. The embodiments set forth herein should not be viewed as limiting; rather, these embodiments are provided merely as examples of the concepts described herein.

While certain embodiments refer to RSS web feeds, the present disclosure is not limited to such uses. For example, the present disclosure may relate to Atom web feeds, webcasting, multicasting, newsreader, and podcasting applications, as well as similar other data distribution technologies. The term “RSS” itself may refer to one of several different web feed standards, such as Rich Site Summary (RSS 0.91), RDF Site Summary (RSS 0.9 and 1.0), and Really Simple Syndication (RSS 2.0). The present disclosure may relate to any commonly known RSS acronym and standard version.

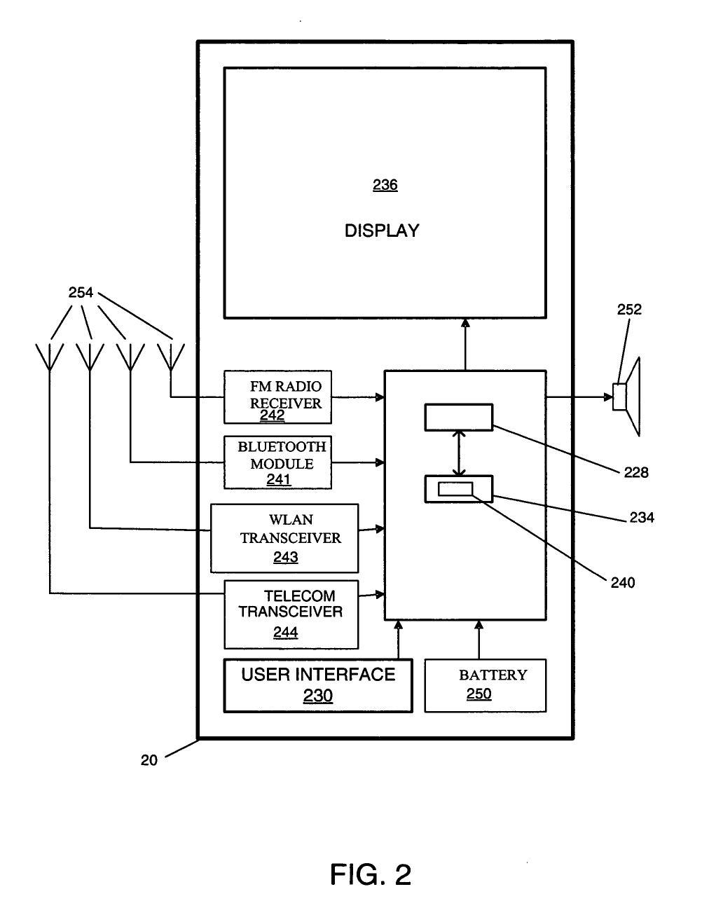

As shown in FIG. 2, mobile terminal 20 may include processor 228 connected to user interface 230, memory 234 and/or other storage, and display 236. Mobile device 212 may also include battery 250, speaker 252 and antennas 254. User interface 230 may further include a keypad, touch screen, voice interface, one or more arrow keys, joy-stick, data glove, mouse, roller ball, touch screen, or the like.

Computer executable instructions and data used by processor 228 and other components within mobile terminal 20 may be stored in a computer readable memory 234. The memory 234 may be implemented with any combination of read only memory modules or random access memory modules, optionally including both volatile and nonvolatile memory and optionally being detachable. Software 240 may be stored within memory 234 and/or storage to provide instructions to processor 228 for enabling mobile terminal 20 to perform various functions. Alternatively, some or all of mobile terminal 20 computer executable instructions may be embodied in hardware or firmware (not shown).

Mobile terminal 20 may be configured to send and receive transmissions based on the Bluetooth standard, through a specific Bluetooth module 241. Additionally, mobile device 212 may also be configured to receive, decode and process transmissions through FM/AM radio receiver 242, wireless local area network (WLAN) transceiver 243, and telecommunications transceiver 244. In one aspect of the invention, mobile terminal 20 may receive radio data stream (RDS) messages. Mobile terminal 20 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal device may share parts or subassemblies with one or more other receivers in the mobile terminal device, or each receiver may be an independent subassembly.

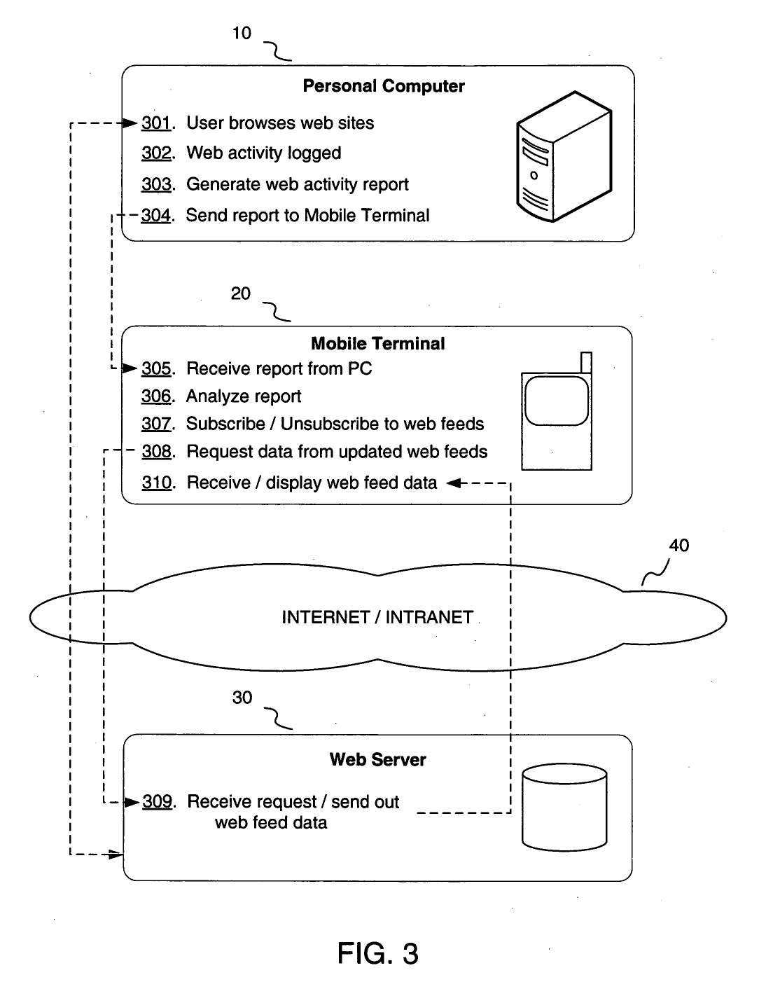

Referring to FIG. 3, a block diagram is shown illustrating steps for establishing web feeds on a mobile terminal 20 in communication with a personal computer (PC) 10. PC 10, for example, a desktop or laptop personal computer, may share data with a nearby mobile terminal 20. The devices 10 and 20 may be connected to form a proximity communication channel, such as a Bluetooth connection enabled by a Bluetooth module 241 in the mobile terminal 20 and a corresponding module in the PC 10. The devices may also be connected via a WLAN, ultra wideband (UWB), or a universal serial bus (USB) connection. An RFID or Infrared connection may also link devices 10 and 20. Additionally, this communication channel may be facilitated by a specialized software application, such as the Nokia PC Suite®, to establish a link between PC 10 and associated mobile terminal 20.

A periodic connection between a mobile terminal 20 and a PC 10 may enable users to transfer files or synchronize data between the devices 10 and 20 when the devices 10 and 20 are in proximity to each other. A user may typically disconnect the devices, for example, keeping the mobile terminal 20 with the user while leaving the PC 10 in the user's home or office. Note that devices 10 and 20 may also be configured to periodically connect to share data even when they are not in close proximity, for example, over an Internet connection using cellular technologies such as third generation (3G) (or newer) or global packet radio service (GPRS) standards.

As mentioned above, both devices 10 and 20 may have the ability to access remote servers 30 over a network 40, for example, to browse the internet and visit web sites. Network 40 may be an internet or intranet, and remote server 30 may be any other computer accessible over a network 40. Thus, in step 301, the user operating PC 10 initiates communication over the network 40 with the remote web server 30, for example, with a web browser application installed on the PC 10.

A web browser application, or browser, refers to a software program installed on a computer, such as PC 10 or mobile terminal 20, designed to communicate with remote servers over a network. For example, PC 10 may have a Microsoft Internet Explorer®, a Netscape Navigator®, or a Mozilla Firefox® brand browser installed to allow users to visit web sites over the internet 40. The browser installed on PC 10 may support plug-ins, or separately installed software programs that may be integrated with the web browser. A plug-in module may add features to the web browser, by providing code to be executed within the browser application space. Common browser plug-ins include modules that may be installed on a PC 10 to enhance the multimedia capabilities of the default browser.

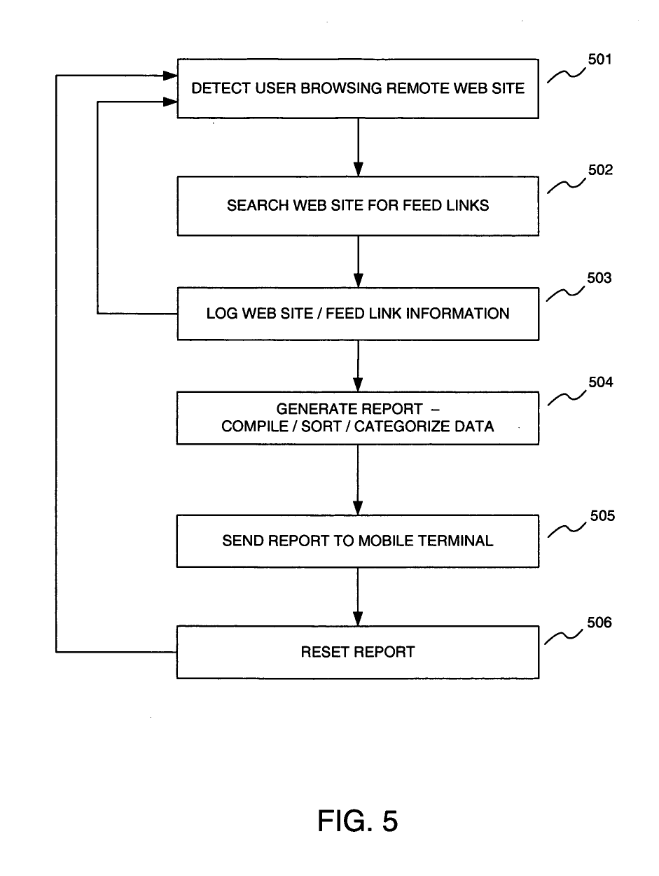

In step 302, the web activity of the user may be logged on PC 10. For example, a plug-in may execute within the browser software on the PC 10 to store information regarding which web sites the user has visited and which of those sites has an associated web feed. In step 303, a software component on the PC 10 may generate a report based on the logged user web activity. The software component generating the user web activity report may be the same plug-in or other component used in step 302, a different browser plug-in, or a separate software component executing outside of the browser. Further details regarding the web activity data that may be logged and stored into the user web activity report is described below in relation to FIG. 5.

In step 304, the user web activity report is sent from the PC 10 to the mobile terminal 20. This report may be sent, for example, via a Bluetooth connection. Thus, the PC 10 and mobile terminal 20 may each have a Bluetooth module installed (e.g., Bluetooth module 241), and may each be configured to automatically detect the other device when they are proximately located. The report may also be transmitted, for example, over a WLAN, USB, UWB, RFID, Infrared, or Internet connection. The present disclosure is not limited to certain methods of communication between PC 10 and mobile terminal 20, and only requires that devices 10 and 20 are able to share data.

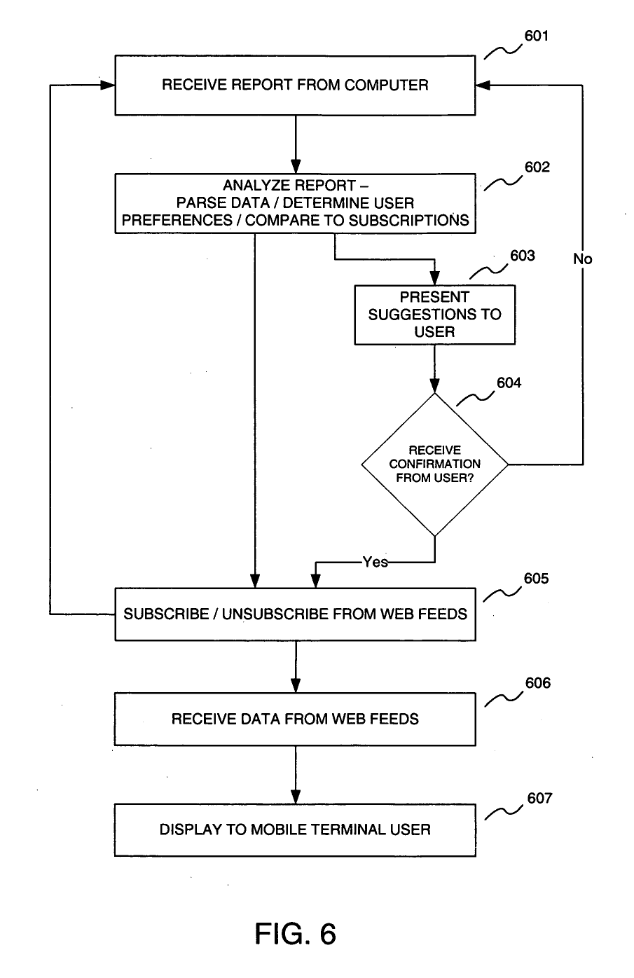

In step 305, the report is received by the mobile terminal 20. The report may be stored in the memory 234 of the mobile terminal 20, and a software component installed on the mobile terminal 20 may be executed by a local processor 228 to analyze the report in step 306 to identify any web feeds identified during the activity occurring during step 301. The logical steps that relate to analyzing the report are discussed in detail in relation to FIG. 6 below.

In step 307, the mobile terminal 20 has identified one or more web feeds to subscribe to or unsubscribe from, on behalf of the user of the mobile terminal 20. The mobile terminal 20 may parse the web feed link address out of the web activity report received from the PC 10, and communicate this information to the reader, or aggregator, of the mobile terminal 20. In step 308, the updated web feeds are used in a content request from the mobile terminal 20. The content request is received and processed by the remote web server 30 in step 309. For example, the remote web server 30 may extract the source address from the network protocol headers to learn the web address of the subscribing mobile terminal 20.

Different web feed subscription URLs supported by a server 30 may also specify the web feed format, since a single remote server 30 may support multiple formats (e.g., RSS, Atom). Additional information included in a subscription URL may relate to the content requested in the web feed or the frequency of the requested web feed content deliveries. In a typical web feed, the remote server 30 will periodically deliver content to subscribers, but will usually not deliver the same content to every subscriber. For example, mobile terminal subscriber 20 may request content delivery from a news web site's remote server 30, but only for a specific news topic, for example, technology news. Meanwhile, another mobile terminal subscriber 20 may subscribe to the same remote server 30 only to receive stock updates. Further, different subscribers may request content deliveries at different times, and the web server 30 may simply respond to requests as they are received from different mobile terminals 20. The different requests may be implemented as different feed link URLs. For example, one feed link URL on a remote server 30 may be associated with a content request for sports news updates in an RSS feed format, while a separate URL format may be associated with a request for stock tracking information delivered in an Atom feed format.

In step 309, remote web server 30 delivers web feed content to the mobile terminal 20, and in step 310 the mobile terminal 20 displays this web feed information to the user on a display 236. Thus, steps 301-310 may enable a user to receive web feed content from a remote web server 30 on a mobile terminal 20, simply by browsing web sites on a PC 10 connected to the mobile terminal 20.

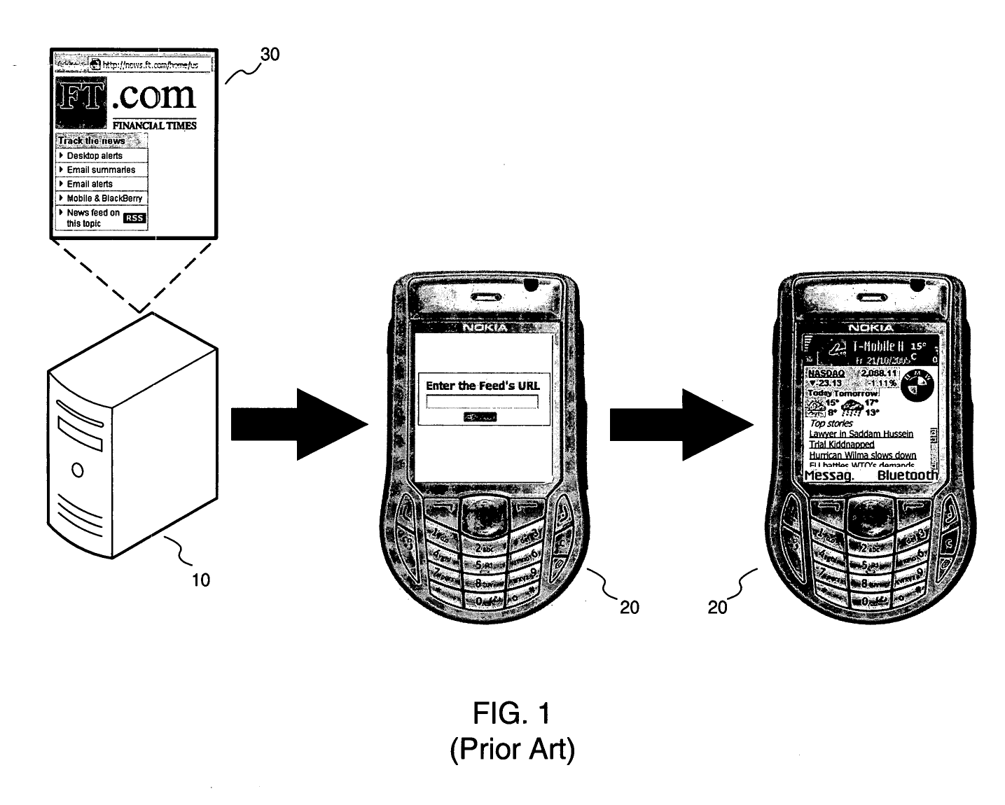

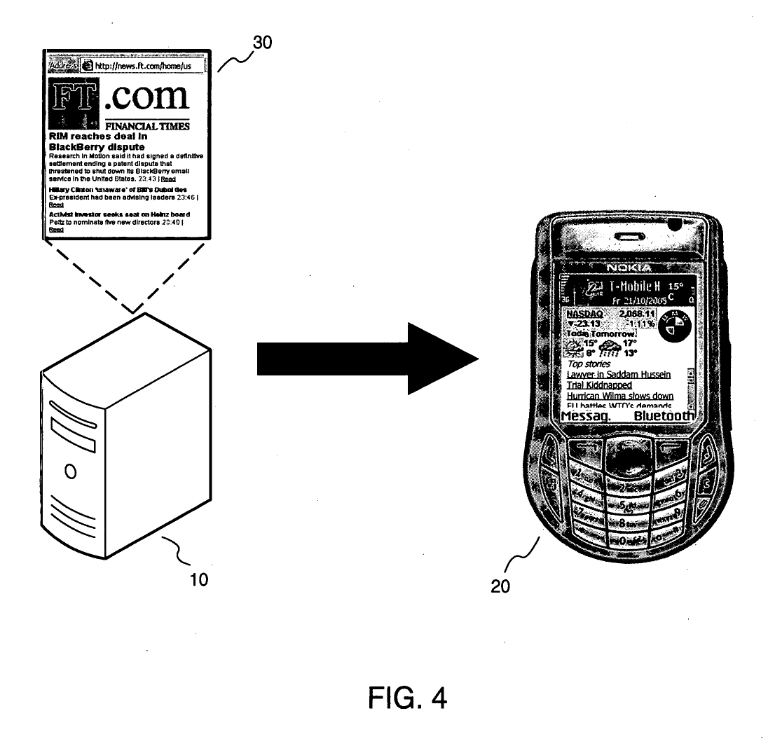

Referring to FIG. 4, a diagram is shown illustrating a method of discovering and subscribing to a web feed on a mobile terminal 20. In contrast to the conventional method illustrated in FIG. 1, several potential advantages are illustrated by this example. The user simply browses the internet 40 on personal computer 10, visiting web sites hosted on remote servers, such as the Financial Times® web server 30. The user need not manually discover the existence of a web feed, such as an RSS feed, on the web site. Instead, the browser plug-in running on computer 10 may detect and record the RSS feed link information without requiring the user to locate the RSS icon on the web site or remember the feed link URL. The RSS feed link URL may then be sent from computer 10 to mobile terminal 20. The mobile terminal 20 may then directly subscribe to the RSS web feed from the remote server 30, without requiring the user to manually input the feed link URL to subscribe to the feed. Thus, in this example, the user may automatically receive RSS web feed content from the remote server 30 on mobile terminal 20, without manually discovering or deploying the RSS feed link, and without regard for the specific underlying web feed technology.

Referring to FIG. 5, a flowchart illustrating more detailed steps by which a computer 10 may generate and send a web activity report for a user to mobile terminal 20 associated with the user is shown. As stated above, a browser plug-in may be installed on PC 10 to detect and log data relating to a user's web browsing activities. A browser plug-in need not be used, since alternative software solutions may also be capable of detecting and recording the user's internet access on the PC 10. However, using a browser plug-in may enjoy certain advantages related to executing in the same application space as the web browser.

In step 501, the browser plug-in software component detects the user visiting a remote network resource, such as a web site on a remote web server 30. In certain embodiments, more than one user may use PC 10 to browse web sites over the internet 40. Thus, the plug-in may detect the specific user operating the computer when a remote web server 30 is visited, for example, by using the system settings of the computer 10, or by identifying any user credentials that are input while the user is visiting the web site.

In step 502, the browser plug-in module searches the web site for any feed links associated with the web site. As mentioned above, many web sites do not support web feeds, and will therefore not contain a feed link. Other sites may have feed links located in different relative locations on the web site, and the feed links themselves may be displayed differently and/or may have different formats on different web sites. Thus, searching a web site for a feed link may involve a text search of the current web page for several key words or phrases to indicate the presence of a feed link (e.g., RSS, Atom, Feed, Update, XML, etc.). A feed link URL may simply be posted as text, or may be implemented as a hyperlink on the web page, thus the plug-in may be configured to search both the text of the web page and the specific hyperlink addresses for possible web feed links. The plug-in may also search additional web pages other than the pages directly accessed by the user, for example, by traversing the web page hierarchies on the web server 30 starting at each page directly accessed by the user. Traversing the web page hierarchies may enable the plug-in to discover feed links that normal web page searches might not, since many web servers may place feed links on different web pages, or may aggregate all feed links on one dedicated web page separate from the other content on the site.

Searching for feed links on web servers may also involve examining the file format of certain web pages, or embedded portions of web pages. For example, RSS feeds and Atom feeds may have extensible markup language (XML) feed documents, and a plug-in may be configured to detect certain known XML tags or namespaces which may identify the feed format, version, and feed link address. In one example, an RSS 2.0 feed document may contain a <rss version=“2.0”> tag, with one or more <channel> and <link> tags which may be identified and read by the plug-in to discover the specific feed link address.

In step 503, the browser plug-in, or other software component running on the PC 10, logs data corresponding to the web sites visited by the user and any associated feed links. For example, the plug-in may log the user's favorites, or most frequently visited web sites, including the amount of time the user spends on the site, and the specific content accessed by the user on the site (e.g., company stock reports, weather forecasts for a local city). Additionally, feed link name, address, description, and format may be logged along with the user's web activity data. The plug-in may simply log every web feed link discovered on the accessed sites, or may instead filter out certain links identified as irrelevant based on specific content or feed format. For example, a news web server may have many different feed links corresponding to different types of news content, and a feed links for entertainment news may be identified as irrelevant for a user that has only ever visited web pages related to world news. Thus, an entertainment news feed link might not be logged, while a world news feed link may be, even though the two links may be found at the same location on the web server 30.

As is shown in FIG. 5, steps 501-503 may repeat each time a user visits a new web server 30 or loads an individual web page. In step 504, an event occurs to trigger the generation of a report including the web activity and feed link data logged in step 503. The generation of the web activity report may be triggered, for example, each time the mobile terminal 20 is connected to the PC 10. Alternatively, a report may be generated according to a schedule, for example, daily or weekly. While the report may be generated by a browser plug-in, certain advantages may result from generating the report with another software component running outside the browser. For example, a scheduled or connection event triggered report could be generated when the browser is not running and without instantiating a browser process on the PC 10. However, a browser plug-in may be used to generate the report, for example, each time the browser process is terminated by the user.

The report may compile and sort the logged data, for example, by placing the user's favorite web sites at the beginning of the report. In certain embodiments, web sites that are infrequently visited by the user, web sites that are disfavored according to the user preferences set at the computer 10, or web sites that do not have any associated web feeds might not be included in the report, since it may be likely that the mobile terminal 20 has no use for data relating to such sites. However, when a user changes his or her preferences via PC 10, resulting in a web site becoming disfavored and thus unsubscribed, such preferences and/or unsubscription may be included in the report. Additionally, the web activity report may be categorized to facilitate parsing by the mobile terminal 20. Certain content categories may be predetermined (e.g., News, Weather, Car, Music, etc.), and the web activity and feed link information may be placed in one of the predetermined categories if possible, for example, by a keyword search of the content on the site.

In step 505, the report is sent from the PC 10 to the mobile terminal 20, for example, via a Bluetooth communication channel. As mentioned above, the report may also be transmitted, for example, over a WLAN, USB, UWB, RFID, Infrared, or Internet connection between the devices 10 and 20.

In step 506, the report may be reset, for example, by clearing the report data and erasing the log file(s). The log files may be cleared, for example, immediately after the generation of the report, or after the transmission of the report to the mobile terminal 20. Alternatively, the report and the log files might not be cleared, but may persist the data and simply add to it the next time the user browses web sites. In one example, the older data from the log files is erased while the newer data is preserved. In certain similar embodiments, more recent web usage data is weighted more heavily than older data during the generation of a report.

Referring to FIG. 6, a flowchart is shown illustrating more detailed steps for a mobile terminal 20 receiving a web activity report and subscribing or unsubscribing to web feeds based on that report. The steps described in FIG. 6 may be performed by one or more software components installed on the mobile terminal 20. These components may be integrated into an aggregator configured to manage web feed subscriptions and receive web feed content, such as syndicated content from RSS feeds. An aggregator is able to subscribe to a feed, check for new content at user-determined intervals, and retrieve the content. The content is sometimes described as being ‘pulled’ to the subscriber, as opposed to ‘pushed’ as with an email or instant messaging application. Unlike recipients of some ‘pushed’ information, the aggregator user can easily unsubscribe from a feed. Mobile terminal 20 may have a built-in aggregator, or a user may subsequently install aggregator software onto the mobile terminal 20.

In step 601, mobile terminal 20 receives a web activity report from PC 10, for example, over a predetermine Bluetooth communication channel. In step 602, a software component on the mobile terminal 20 analyzes the web activity report received from the PC 10, to identify certain web feeds potentially relevant to the mobile terminal user. Any web feed link addresses may be parsed out of the report, and web activity information such as the frequency of visits to a certain web site may allow the mobile terminal 20 to determine whether or not a certain feed should be added or removed from the mobile terminal's 20 subscription list. The list of web feed links in the report may be compared to the current subscription list of the mobile terminal 20 to help determine subscription actions. For example, a web site frequently visited by the user on the PC 10 with an associated RSS feed may be a likely candidate for establishing a feed subscription, if the mobile terminal 20 is not already a subscriber of the RSS feed. Similarly, a current RSS feed may be a likely candidate for canceling the free subscription, if little or no user access to that web site has recently occurred on the PC 10. Also, a subscription may be cancelled automatically if the user of the mobile terminal 10 does not consume the content received via the web feed on the mobile terminal 10 within a predetermined length of time, for example, a month.

In certain embodiments, the report may be analyzed along with user preferences stored on the mobile terminal 20 relating to web feeds. For example, a user may prefer to receive only feeds in certain formats (e.g., RSS). Such a preference may be determined automatically by the feed reader, or feed aggregator, software installed on the mobile terminal 20. As another example, a user may prefer to be a subscriber to no more than twenty feeds at one time. Besides specifying a maximum, minimum, or preferred number of feed subscriptions, additional user preferences may relate to the content or categories of feeds. For example, a user may specify on mobile terminal 20 that regardless of the number or frequency of entertainment news web sites she visited on PC 10, the user should not be subscribed to any entertainment news web feeds. A converse preference type may also be specified by a user, for example, despite not recently visiting any technology-related web sites on PC 10, no current technology-related feeds subscriptions should be cancelled unless specified explicitly by the user. Thus, user preferences, such as those shown in the above examples, demonstrate that the automatic feed link deployment described in the present disclosure may be considerably customizable or placed within certain user-specified guidelines for web feed subscription behavior.

Optional steps 603 and 604 relate to presenting the subscription suggestions determined in step 602 to the mobile terminal user, and receiving a confirmation from the user before updating the subscriptions on the mobile terminal 20. In certain embodiments, web feeds may be subscribed to and unsubscribed from automatically by the software component in the mobile terminal 20. Thus, step 602 may proceed directly to step 605, as described below. Alternatively, the web feed suggestions may be first presented to the user in step 603, for confirmation in step 604, before any subscribe/unsubscribe action is taken. In step 604, the user may review these subscription suggestions, for example, by viewing a list of feed names and brief descriptions displayed on the display screen 236 of the mobile terminal 20. If the user confirms one or more of the subscription suggestions, then the corresponding subscribe/unsubscribe action is taken in step 605. If the user rejects all of the subscription suggestions, then any potential subscribe/unsubscribe action may be foreclosed, and the mobile terminal 20 may go back to step 601 to await the next report from PC 10. Thus, allowing the user to confirm subscription suggestions provides the user knowledge and control over the current set of web feed subscriptions, and still does not require the user to manually discover the feed link or input the link URL into the mobile terminal 20.

In step 605, the set of new web feeds for subscribing and existing web feeds for unsubscribing is finalized. The mobile terminal 20 then executes these subscribe/unsubscribe actions, for example, by communicating the recent subscription changes to the local reader or aggregator, such as an RSS reader.

The mobile terminal 20 may then go back to step 601 and await the next report from PC 10, while simultaneously awaiting delivery content from the current set of web feeds in step 606, so that the web feed data such as news updates may be displayed to the user in step 607.

While a one-to-one relationship between a PC 10 and mobile terminal 20 may be typical in some embodiments, the present disclosure is not limited to such uses. For example, in certain embodiments several different mobile terminals 20, each associated with a different user, may be connected to a single PC 10. Thus, the present disclosure may also support the creation of multiple sets of log files and multiple reports sent out by PC 10 to the various mobile terminals 20. Thus, each mobile terminal user may receive automation web feed updating based on their personal web activity and user preferences, rather than based on the web activities of other users of the same PC 10.

While the foregoing descriptions and the associated drawings may relate to discovery and deployment of a feed link at a mobile terminal, many modifications and other embodiments will come to mind to one skilled in the art having the benefit of the teachings presented.

What is claimed is:

1. A method for displaying data on a mobile terminal comprising the steps of:
receiving information from a computer relating to a network resource accessed by a user of the mobile terminal;
automatically identifying a feed link from said information;
subscribing to said feed link;
receiving data from a feed associated with said feed link; and
displaying said data on a display screen of said mobile terminal.

2. The method of claim 1, wherein said information received from said computer is formatted in accordance with one of a Bluetooth, wireless local area network (WLAN), universal serial bus (USB), ultra wideband (UWB), third-generation (3G), and global packet radio service (GPRS) network communication protocol.

3. The method of claim 1, wherein said feed link is an RSS feed link.

4. The method of claim 1, wherein the information relating to a network resource comprises an internet usage log associated with said user, and the step of identifying a feed link comprises identifying a web site visited by said user.

5. The method of claim 1, wherein the step of subscribing to said feed link occurs without a user action on said mobile terminal directed to subscribing to said feed link.

6. The method of claim 1, wherein the step of subscribing to said feed link comprises:
displaying a recommendation to said user on said mobile terminal relating to the feed link; and
receiving a confirmation from said user.

7. The method of claim 1, further comprising the steps of:
automatically identifying a second feed link from said information, wherein said second feed link is associated with a second web site not frequently visited by said user; and
unsubscribing from said second feed link.

8. A method for sending information to a mobile terminal comprising the steps of:
receiving at a computer input from a user, said input relating to a network resource;
identifying a network address based on said user input;
identifying a feed link associated with said network address;
identifying a mobile terminal associated with said user; and
sending information corresponding to said feed link to said mobile terminal.

9. The method of claim 8, wherein said step of sending information comprises transmitting data in accordance with one of a Bluetooth, wireless local area network (WLAN), universal serial bus (USB), ultra wideband (UWB), third-generation (3G), and global packet radio service (GPRS) network communication protocol.

10. The method of claim 8, wherein said feed link is an RSS feed link.

11. The method of claim 8, wherein receiving said user input comprises detecting a web site visited by the user at the computer.

12. A mobile terminal comprising:
a display screen;
a processor controlling at least some operations of the mobile terminal;
a memory storing computer executable instructions that, when executed by the processor, cause the mobile terminal to perform a method for displaying data from a feed, said method comprising steps of:
receiving from a computer information relating to a network resource accessed by a user of the mobile terminal;
identifying a feed link from said information;
subscribing to said feed link;
receiving data from a feed associated with said feed link; and
displaying said data on said display screen.

13. The mobile terminal of claim 12, wherein said information received from said computer is formatted in accordance with one of a Bluetooth, wireless local area network (WLAN), universal serial bus (USB), ultra wideband (UWB), third-generation (3G), and global packet radio service (GPRS) network communication protocol.

14. The mobile terminal of claim 12, wherein said feed link is an RSS feed link.

15. The mobile terminal of claim 12, wherein the information relating to a network resource comprises an internet usage log associated with said user, and the step of identifying a feed link comprises identifying a web site visited by said user.

16. The mobile terminal of claim 12, wherein the step of subscribing to said feed link occurs without a user action on said mobile terminal directed to subscribing to said feed link.

17. The mobile terminal of claim 12, wherein the step of subscribing to said feed link comprises:
displaying a recommendation to said user on said mobile terminal relating to the feed link; and
receiving a confirmation from said user.

18. The mobile terminal of claim 12, said method further comprising the steps of:
identifying a second feed link from said information, wherein said second feed is associated with a second web site not frequently visited by said user; and
unsubscribing from said second feed link.

19. The mobile terminal of claim 12, said method further comprising the steps of:
identifying a second feed link from said information, said second feed link currently subscribed to by said mobile terminal;
determining that feed content from said second feed link has not been consumed by said user at said mobile terminal in a predetermined length of time; and
unsubscribing from said second feed link based on the determining step.

20. One or more computer readable media storing computer-executable instructions that, when executed by a mobile terminal device, perform a method comprising steps of:
(a) receiving information from a computer relating to a network resource accessed from said computer, by a user associated with said computer and said mobile terminal;
(b) automatically identifying a feed link from said information;
(c) subscribing to said feed link;
(d) receiving data from a feed associated with said feed link; and
(e) displaying said data on a display screen of said mobile terminal.

21. The computer readable media of claim 20, wherein said mobile terminal is a Bluetooth-enabled wireless terminal and said information received from said computer is formatted in accordance with a Bluetooth wireless protocol.

22. The computer readable media of claim 20, wherein said feed link is an RSS feed link.

23. The computer readable media of claim 20, wherein the information relating to a network resource comprises an internet usage log associated with said user, and the step of identifying a feed link comprises identifying a web site visited by said user.

24. The computer readable media of claim 20, wherein the step of subscribing to said feed link occurs without a user action on said mobile terminal directed to subscribing to said feed link.

25. The computer readable media of claim 20, wherein the step of subscribing to said feed link comprises:
displaying a recommendation to said user on said mobile terminal relating to the feed link; and
receiving a confirmation from said user.

26. The computer readable media of claim 20, said method further comprising the steps of:
automatically identifying a second feed link from said information, wherein said second feed link is associated with a second web site not frequently visited by said user; and
unsubscribing from said second feed link.
